(19) United States
(12) Patent Application Publication
(10) Pub. No.: US 2022/0270419 A1
(43) Pub. Date: Aug. 25, 2022

(54) VEHICLE DIAGNOSIS METHOD AND APPARATUS AND STORAGE MEDIUM

(71) Applicant: AUTEL INTELLIGENT TECHNOLOGY CORP., LTD., Shenzhen (CN)

(72) Inventor: Yuexi Yang, Shenzhen (CN)

(21) Appl. No.: 17/145,315

(22) Filed: Jan. 9, 2021

Related U.S. Application Data
(63) Continuation of application No. PCT/CN2019/090105, filed on Jun. 5, 2019.

(30) Foreign Application Priority Data
Jul. 20, 2018 (CN) 2018108006057

(51) Int. Cl. G07C 5/08; G07C 5/00

(52) U.S. Cl. CPC G07C 5/0825; G07C 5/0808; G07C 5/008

(57) ABSTRACT

The present invention provides a vehicle diagnosis method and apparatus and a storage medium. N system parameters of a vehicle to be diagnosed are acquired, and M detection items are determined according to the N system parameters to obtain a detection plan including the M detection items; and the detection plan is displayed, so that a user operates the vehicle to be diagnosed according to the detection items in the detection plan. According to the vehicle diagnosis method and apparatus and the storage medium provided by the present invention, multiple types of detection plans including detection items with different priorities can be obtained through common comprehensive evaluation according to N system parameters, and then a relatively complete and comprehensive detection plan can be made according to the correlation among all the system parameters, so that the efficiency in vehicle diagnosis is improved.

This application is a continuation of International Patent Application No. PCT/CN2019/090105 filed on Jun. 5, 2019, which claims priority to Chinese Patent Application No. 201810800605.7 filed on Jul. 20, 2018, both of which are incorporated by reference herein in their entireties.

### BACKGROUND

### Technical Field

The present application relates to the technical field of vehicles, and more particularly, to a vehicle diagnosis method and apparatus and a storage medium.

### Related Art

With the continuous development of a vehicle technology, people pay more and more attention to the safety performance of vehicles in the use process, after a period of time or a certain number of mileages, the vehicles may be diagnosed and detected and subjected to corresponding fault maintenance.

In the prior art, when diagnosing and detecting existing problems of a vehicle, firstly, a maintenance person scans an electronic control system of the vehicle by using a vehicle diagnosis device, and the diagnosis device can obtain diagnosis parameters of the vehicle according to read data of the electronic control system of the vehicle; then, after various diagnosis parameters obtained by the vehicle diagnosis device are detected, observed and analyzed by the maintenance person, vehicle fault reasons, components and maintenance operations which need to be performed on the vehicle are determined; and finally, after the maintenance person performs corresponding maintenance and component replacement on the vehicle, a diagnosis instrument may be used for confirming whether the fault of the vehicle is eliminated.

By adopting the prior art, since the diagnosis device can only list one or more diagnosis parameters or fault codes according to the parameters of the electronic control system of the vehicle, the existence of each fault problem can be displayed singly, and a complete and comprehensive fault solution cannot be formulated according to the correlation among the faults. Therefore, when the vehicle is diagnosed, all faults need to be analyzed and processed completely depending on experience knowledge of the maintenance person, so that the efficiency in vehicle diagnosis is low.

### SUMMARY

The present invention provides a vehicle diagnosis method and apparatus and a storage medium, which improve the efficiency in vehicle diagnosis.

In a first aspect of the present invention, a vehicle diagnosis method is provided. The vehicle diagnosis method includes:

acquiring N system parameters of a vehicle to be diagnosed, N being a positive integer; determining M detection items according to the N system parameters to obtain a detection plan including the M detection items, M being a positive integer; and

displaying the detection plan, so that a user operates the vehicle to be diagnosed according to the detection items in the detection plan.

In an embodiment of the first aspect of the present invention, acquiring N system parameters of a vehicle to be diagnosed includes:

acquiring, after establishing a communication with the vehicle to be diagnosed, the N system parameters from at least one system of the vehicle to be diagnosed; and/or,

acquiring the N system parameters of the vehicle to be diagnosed according to an input operation of the user.

In an embodiment of the first aspect of the present invention, determining M detection items according to the N system parameters includes:

determining M detection items corresponding to the N system parameters according to a corresponding relationship between system parameters and detection items.

In an embodiment of the first aspect of the present invention, determining M detection items corresponding to the N system parameters according to a corresponding relationship between system parameters and detection items includes:

determining detection items corresponding to all system parameters in the N system parameters; and

determining M detection items from the detection items corresponding to all the system parameters.

In an embodiment of the first aspect of the present invention, determining M detection items from the detection items corresponding to all the system parameters includes:

determining M identical detection items in the detection items corresponding to all the system parameters; and

taking the M identical detection items as the M detection items.

In an embodiment of the first aspect of the present invention, determining M detection items from the detection items corresponding to all the system parameters includes:

deleting repeated detection items in the detection items corresponding to all the system parameters, and taking M detection items remaining after deletion as the M detection items.

In an embodiment of the first aspect of the present invention, determining M detection items according to the N system parameters includes:

determining a detection plan of the vehicle to be diagnosed according to the N system parameters in combination with at least one of historical detection data of the vehicle to be diagnosed and detection data related to the vehicle to be diagnosed.

In an embodiment of the first aspect of the present invention, determining M detection items according to the N system parameters includes:

sending the N system parameters to a server, so that the server determines M detection items of the vehicle to be diagnosed according to the N system parameters; and

receiving the M detection items of the vehicle to be diagnosed sent by the server.

In an embodiment of the first aspect of the present invention, the method further includes:

determining priorities of the M detection items; and

prioritizing the M detection items in the detection plan to obtain a prioritizing result.

Displaying the detection plan includes:

displaying the M detection items in the detection plan according to the prioritizing result.

In an embodiment of the first aspect of the present invention, determining priorities of the M detection items includes:

determining priorities of the M detection items according to the importance of detection objects corresponding to the detection items; or,

determining priorities of the M detection items according to the degree of correlation between the detection items.

In an embodiment of the first aspect of the present invention, after displaying the detection plan, the method further includes:

receiving system parameters or detection items input by a user; and

updating the detection plan according to the system parameters or the detection items input by the user.

In an embodiment of the first aspect of the present invention, the method further includes:

receiving a first operation of a user for one of the M detection items; and

running the detection item according to the first operation.

In an embodiment of the first aspect of the present invention, the method further includes:

receiving a second operation of a user for one of the M detection items; and

displaying at least one detection function related to the detection item according to the second operation.

In an embodiment of the first aspect of the present invention, the method further includes:

receiving a third operation of a user for one of the M detection items; and

displaying auxiliary information of the detection item according to the third operation.

In an embodiment of the first aspect of the present invention, the method further includes:

receiving a fourth operation of a user for one of the M detection items; and

displaying detailed description information of the detection item according to the fourth operation.

In an embodiment of the first aspect of the present invention, the method further includes:

updating, after detecting that a user operates the vehicle to be diagnosed according to a detection item in the detection plan, an execution state of the detection item according to the operation of the user for the vehicle to be diagnosed.

In an embodiment of the first aspect of the present invention, displaying the detection plan includes: displaying at least one of the following information:

types of all detection items included in the detection plan, description information of all detection items, execution states of all detection items and priorities of all detection items.

In an embodiment of the first aspect of the present invention, the system parameters include at least one of the following: vehicle information, system information, sensor state, module state, fault code and fault symptom of the vehicle to be diagnosed.

In conclusion, in the vehicle diagnosis method provided in the first aspect of the present invention, N system parameters of a vehicle to be diagnosed are acquired, and M detection items are determined according to the N system parameters to obtain a detection plan including the M detection items; and the detection plan is displayed, so that a user operates the vehicle to be diagnosed according to the detection items in the detection plan. Thus, multiple types of detection plans including detection items with different priorities can be obtained through common comprehensive evaluation according to N system parameters, and then a relatively complete and comprehensive detection plan can be made according to the mutual correlation among all the system parameters, thereby improving the efficiency in vehicle diagnosis.

In a second aspect of the present invention, a vehicle diagnosis apparatus is provided. The vehicle diagnosis apparatus includes:

an acquisition module, configured to acquire N system parameters of a vehicle to be diagnosed, N being a positive integer;

a processing module, configured to determine M detection items according to the N system parameters to obtain a detection plan including the M detection items, M being a positive integer; and

a display module, configured to display the detection plan, so that a user operates the vehicle to be diagnosed according to the detection items in the detection plan.

In an embodiment of the second aspect of the present invention, the acquisition module is specifically configured to:

acquire, after establishing a communication with the vehicle to be diagnosed, the N system parameters from at least one system of the vehicle to be diagnosed; and/or,

acquire the system parameters of the vehicle to be diagnosed according to an input operation of the user.

In an embodiment of the second aspect of the present invention, the processing module is specifically configured to:

determine M detection items corresponding to the N system parameters according to a corresponding relationship between system parameters and detection items.

In an embodiment of the second aspect of the present invention, the processing module is specifically configured to:

determine detection items corresponding to all system parameters in the N system parameters; and

determine M detection items from the detection items corresponding to all the system parameters.

In an embodiment of the second aspect of the present invention, the processing module is specifically configured to:

determine M identical detection items in the detection items corresponding to all the system parameters; and

take the M identical detection items as the M detection items.

In an embodiment of the second aspect of the present invention, the processing module is specifically configured to:

delete repeated detection items in the detection items corresponding to all the system parameters, and take M detection items remaining after deletion as the M detection items.

In an embodiment of the second aspect of the present invention, the processing module is specifically configured to:

determine a detection plan of the vehicle to be diagnosed according to the N system parameters in combination with at least one of historical detection data of the vehicle to be diagnosed and detection data related to the vehicle to be diagnosed.

In an embodiment of the second aspect of the present invention, the apparatus further includes:

a sending module, configured to send the N system parameters to a server, so that the server determines M detection items of the vehicle to be diagnosed according to the N system parameters; and

a receiving module, configured to receive the M detection items of the vehicle to be diagnosed sent by the server.

In an embodiment of the second aspect of the present invention, the processing module is further configured to:

determine priorities of the M detection items; and

prioritize the M detection items in the detection plan to obtain a prioritizing result.

The processing module is further configured to display the M detection items in the detection plan according to the prioritizing result.

In an embodiment of the second aspect of the present invention, the processing module is specifically configured to:

determine priorities of the M detection items according to the importance of detection objects corresponding to the detection items; or,

determine priorities of the M detection items according to the degree of correlation between the detection items.

In an embodiment of the second aspect of the present invention, the processing module is further configured to:

receive system parameters or detection items input by a user; and

update the detection plan according to the system parameters or the detection items input by the user.

In an embodiment of the second aspect of the present invention, the processing module is further configured to:

receive a first operation of a user for one of the M detection items; and

run the detection item according to the first operation.

In an embodiment of the second aspect of the present invention, the processing module is further configured to:

receive a second operation of a user for one of the M detection items.

The display module is further configured to display at least one detection function related to the detection item according to the second operation.

In an embodiment of the second aspect of the present invention, the processing module is further configured to:

receive a third operation of a user for one of the M detection items.

The display module is further configured to display auxiliary information of the detection item according to the third operation.

In an embodiment of the second aspect of the present invention, the processing module is further configured to:

receive a fourth operation of a user for one of the M detection items.

The display module is further configured to display detailed description information of the detection item according to the fourth operation.

In an embodiment of the second aspect of the present invention, the processing module is further configured to:

update, after detecting that a user operates the vehicle to be diagnosed according to a detection item in the detection plan, an execution state of the detection item according to the operation of the user for the vehicle to be diagnosed.

In an embodiment of the second aspect of the present invention, the display module is specifically configured to display at least one of the following information:

types of all detection items included in the detection plan, description information of all detection items, execution states of all detection items and priorities of all detection items.

In an embodiment of the second aspect of the present invention, the system parameters include at least one of the following:

vehicle information, system information, sensor state, module state, fault code and fault symptom of the vehicle to be diagnosed.

In conclusion, in the vehicle diagnosis apparatus provided in the second aspect of the present invention, N system parameters of a vehicle to be diagnosed are acquired, and M detection items are determined according to the N system parameters to obtain a detection plan including the M detection items; and the detection plan is displayed, so that a user operates the vehicle to be diagnosed according to the detection items in the detection plan. Thus, multiple types of detection plans including detection items with different priorities can be obtained through common comprehensive evaluation according to N system parameters, and then a relatively complete and comprehensive detection plan can be made according to the mutual correlation among all the system parameters, thereby improving the efficiency in vehicle diagnosis.

In a third aspect of the present application, a vehicle diagnosis apparatus is provided. The vehicle diagnosis apparatus includes:

a processor, configured to acquire N system parameters of a vehicle to be diagnosed, N being a positive integer, the processor being further configured to determine M detection items according to the N system parameters to obtain a detection plan including the M detection items, M being a positive integer; and

a display, configured to display the detection plan, so that a user operates the vehicle to be diagnosed according to the detection items in the detection plan.

In an embodiment of the third aspect of the present invention, the processor is specifically configured to:

acquire, after establishing a communication with the vehicle to be diagnosed, the N system parameters from at least one system of the vehicle to be diagnosed; and/or,

acquire the system parameters of the vehicle to be diagnosed according to an input operation of the user.

In an embodiment of the third aspect of the present invention, the processor is specifically configured to:

determine M detection items corresponding to the N system parameters according to a corresponding relationship between system parameters and detection items.

In an embodiment of the third aspect of the present invention, the processor is specifically configured to:

determine detection items corresponding to all system parameters in the N system parameters; and

determine M detection items from the detection items corresponding to all the system parameters.

In an embodiment of the third aspect of the present invention, the processor is specifically configured to:

determine M identical detection items in the detection items corresponding to all the system parameters; and

take the M identical detection items as the M detection items.

In an embodiment of the third aspect of the present invention, the processor is specifically configured to:

delete repeated detection items in the detection items corresponding to all the system parameters, and take M detection items remaining after deletion as the M detection items.

In an embodiment of the third aspect of the present invention, the processor is specifically configured to:

determine a detection plan of the vehicle to be diagnosed according to the N system parameters in combination with at least one of historical detection data of the vehicle to be diagnosed and detection data related to the vehicle to be diagnosed.

In an embodiment of the third aspect of the present invention, the apparatus further includes:

a sender, configured to send the N system parameters to a server, so that the server determines M detection items of the vehicle to be diagnosed according to the N system parameters; and

a receiver, configured to receive the M detection items of the vehicle to be diagnosed sent by the server.

In an embodiment of the third aspect of the present invention, the processor is further configured to:

determine priorities of the M detection items; and

prioritize the M detection items in the detection plan to obtain a prioritizing result.

The processor is further configured to display the M detection items in the detection plan according to the prioritizing result.

In an embodiment of the third aspect of the present invention, the processor is specifically configured to:

determine priorities of the M detection items according to the importance of detection objects corresponding to the detection items; or,

determine priorities of the M detection items according to the degree of correlation between the detection items.

In an embodiment of the third aspect of the present invention, the processor is further configured to:

receive system parameters or detection items input by a user; and

update the detection plan according to the system parameters or the detection items input by the user.

In an embodiment of the third aspect of the present invention, the processor is further configured to:

receive a first operation of a user for one of the M detection items; and

run the detection item according to the first operation.

In an embodiment of the third aspect of the present invention, the processor is further configured to:

receive a second operation of a user for one of the M detection items.

The display is further configured to display at least one detection function related to the detection item according to the second operation.

In an embodiment of the third aspect of the present invention, the processor is further configured to:

receive a third operation of a user for one of the M detection items.

The display is further configured to display auxiliary information of the detection item according to the third operation.

In an embodiment of the third aspect of the present invention, the processor is further configured to:

receive a fourth operation of a user for one of the M detection items.

The display is further configured to display detailed description information of the detection item according to the fourth operation.

In an embodiment of the third aspect of the present invention, the processor is further configured to:

update, after detecting that a user operates the vehicle to be diagnosed according to a detection item in the detection plan, an execution state of the detection item according to the operation of the user for the vehicle to be diagnosed.

In an embodiment of the third aspect of the present invention, the display is specifically configured to display at least one of the following information:

types of all detection items included in the detection plan, description information of all detection items, execution states of all detection items and priorities of all detection items.

In an embodiment of the third aspect of the present invention, the system parameters include at least one of the following:

vehicle information, system information, sensor state, module state, fault code and fault symptom of the vehicle to be diagnosed.

In a fourth aspect, an embodiment of the present application provides an electronic device. The electronic device includes a processor and a memory. The memory is configured to store programs. The processor is configured to call the programs stored in the memory to execute the vehicle diagnosis method as described in any of the foregoing in the first aspect of the present application.

In a fifth aspect, an embodiment of the present application provides a storage medium. The storage medium stores a computer program which, when executed, executes the vehicle diagnosis method as described in any of the foregoing in the first aspect of the present application.

### BRIEF DESCRIPTION OF THE DRAWINGS

To describe the technical solutions in the embodiments of the present invention or in the existing technology more clearly, the following briefly describes the accompanying drawings required for describing the embodiments or the existing technology. Apparently, the accompanying drawings in the following description show merely some embodiments of the present invention, and a person of ordinary skill in the art may still derive other drawings from these accompanying drawings without creative efforts.

FIG. 1 is a schematic diagram of an application system structure of a vehicle diagnosis method according to an embodiment of the present invention.

FIG. 2 is a schematic flow diagram of Embodiment 1 of a vehicle diagnosis method of the present invention.

FIG. 3 is a schematic diagram of a detection plan in a vehicle diagnosis method of the present invention.

FIG. 4 is a schematic flow diagram of Embodiment 2 of a vehicle diagnosis method of the present invention.

FIG. 5 is a schematic flow diagram of Embodiment 3 of a vehicle diagnosis method of the present invention.

FIG. 6 is a schematic structure diagram of Embodiment 1 of a vehicle diagnosis apparatus of the present invention.

FIG. 7 is a schematic structure diagram of Embodiment 2 of a vehicle diagnosis apparatus of the present invention.

FIG. 8 is a schematic structure diagram of Embodiment 3 of a vehicle diagnosis apparatus of the present invention.

FIG. 9 is a schematic structure diagram of Embodiment 4 of a vehicle diagnosis apparatus of the present invention.

The foregoing accompanying drawings show specific embodiments of the present disclosure, and more detailed descriptions are provided in the following. The accompanying drawings and text descriptions are not intended to limit the scope of the idea of the present disclosure in any form, but are intended to explain the concept of the present disclosure to a person skilled in the art with reference to particular embodiments. The following describes technical solutions of the present invention in detail with reference to specific embodiments. The following specific embodiments may be combined with each other, and the same or similar concepts or processes may not be repeated in some embodiments.

### DETAILED DESCRIPTION

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

In the specification, claims, and accompanying drawings of the present invention, the terms “first”, “second”, “third”, “fourth”, and so on (if existent) are intended to distinguish between similar objects rather than describe a specific order or sequence. It should be understood that the data used in such a way are interchangeable in proper circumstances so that the embodiments of the present invention described herein can be implemented in orders except the order illustrated or described herein. In addition, the terms “include”, “comprise” and any other variants are intended to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

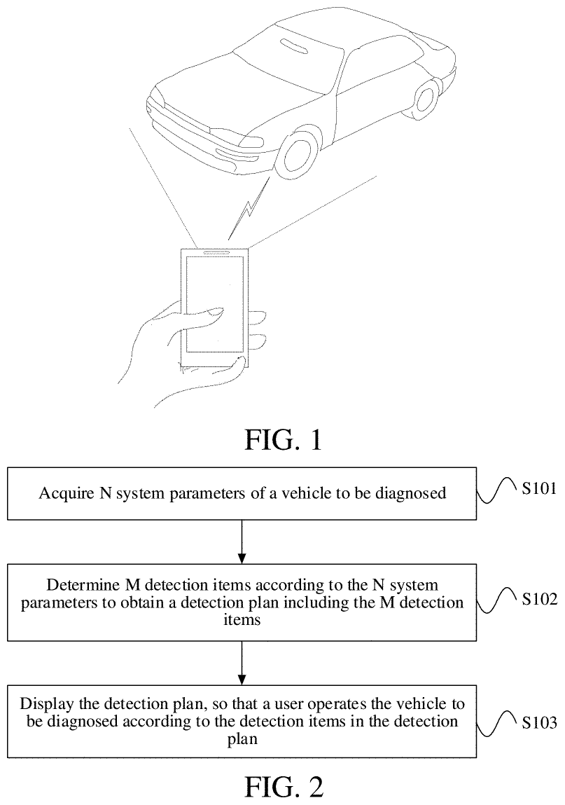

FIG. 1 is a schematic diagram of an application system structure of a vehicle diagnosis method according to an embodiment of the present invention. As shown in FIG. 1, a vehicle to be diagnosed is scanned by a user or a maintenance person manually or otherwise manipulating an electronic device for vehicle diagnosis, such as a vehicle diagnosis device or other special tools. Here, scanning the vehicle to be diagnosed may refer to communicating with an electronic control unit (ECU) or an electronic control system in the vehicle to acquire data in the electronic control unit. The embodiments of the present invention are illustrated by taking a vehicle diagnosis device as an example. The communication between the vehicle diagnosis device and the vehicle may be implemented through a wired or wireless connection. The vehicle diagnosis device may be connected to an OBD interface of the vehicle through a vehicle communication interface (VCI).

Specifically, the diagnosis device can, for example, collect system data of a vehicle engine system, a vehicle electronic control fault diagnosis system, an exhaust gas analysis system, a smoke opacity measurement system and a chassis suspension system through system parameters of the vehicle obtained according to the read data of the electronic control unit (ECU) of the vehicle. Then, after various system parameters of the vehicle are detected, observed and analyzed by the maintenance person, vehicle fault reasons, components and maintenance operations which need to be performed on the vehicle are determined. Finally, after the maintenance person performs corresponding maintenance operations and component replacement on the vehicle, a diagnosis instrument is used for confirming whether the fault of the vehicle is eliminated.

However, there are the following problems in the prior art. Since the diagnosis device can only list one or more system parameters or fault codes, the existence of each fault problem can be displayed singly, and a complete and comprehensive fault solution cannot be formulated according to the correlation among the faults. When the vehicle is diagnosed, all faults need to be analyzed and processed completely depending on experience knowledge of the maintenance person, so that the efficiency in vehicle diagnosis is low.

The embodiments of the present invention provide a vehicle diagnosis method and apparatus, which improve the efficiency in vehicle diagnosis.

Specifically, FIG. 2 is a schematic flow diagram of Embodiment 1 of a vehicle diagnosis method of the present invention. As shown in FIG. 2, the vehicle diagnosis method provided in this embodiment includes the following steps.

In S101, N system parameters of a vehicle to be diagnosed are acquired, N being a positive integer.

In S102, M detection items are determined according to the N system parameters to obtain a detection plan including the M detection items, M being a positive integer.

In this step, when an electronic device diagnoses a vehicle to be diagnosed, system parameters of the vehicle to be diagnosed are firstly acquired. The executive body of this embodiment may be an electronic device with functions of acquiring vehicle system parameters and related data processing. For example, the electronic device is a terminal installed with an application program for vehicle diagnosis, such as a mobile phone and a tablet computer. The electronic device may include a vehicle diagnosis device, a special diagnosis tool, etc.

Optionally, the system parameters include at least one or more of the following: vehicle information, system information, sensor state, module state, fault code and fault state of the vehicle to be diagnosed.

The vehicle information of the vehicle to be diagnosed includes the brand, model number, year, vehicle identification number (VIN), etc. of the vehicle.

The system information mainly refers to related information of an electronic control system of the vehicle to be diagnosed, such as an electronic control system identifier, components included in the electronic control system and vehicle data in the electronic control system.

The sensor state includes the state of each sensor in the vehicle to be diagnosed, for example, states of a water temperature sensor, a tire pressure sensor, an air quality sensor and a temperature sensor. Here, the state of each sensor may be normal or abnormal. Data transmitted by each sensor may be included in data transmitted by the electronic control system.

The module state refers to the state of a body control module in the vehicle to be diagnosed. The body control module is configured to control electricity for a vehicle body, such as a lamp, a windscreen wiper, a door lock and a sunroof.

The fault code and the fault state may be reflected by the ECU analysis of the vehicle to be diagnosed and stored in an ECU or a related storage device of the vehicle. In this embodiment, the fault code and the fault state of the vehicle to be diagnosed are acquired from the ECU or the related storage device. The fault code and the fault state may be understood to mean that the ECU of the vehicle is obtained from the vehicle data analysis of the vehicle. At least one of the foregoing system parameters may be included in the N system parameters. For example, three system parameters obtained in S101 include an engine model (hardware parameter) of the vehicle, an engine running time (hardware parameter) of the vehicle and a software version (software parameter) of an engine system, i.e., the three system parameters are formed by two hardware parameters and one software parameter.

Specifically, in step S102, after the electronic device serving as the executive body acquires N system parameters of a vehicle to be diagnosed, it is also necessary to determine M detection items according to the N system parameters to obtain a detection plan including the M detection items. The detection plan at least includes the M detection items.

For example, the three system parameters of the vehicle to be diagnosed acquired in S101 are that an engine noise is 40 dB, an engine water temperature is 97 degrees Celsius, and an exhaust pipe smoke is black. An overload fault of a vehicle engine is determined according to the fact that the noise of the engine is large and the water temperature is too high, thereby generating a first detection item as engine combustion detection. And it is determined that a vehicle air filter element is plugged according to the fact that the exhaust pipe smoke is black, thereby generating a second detection item as air filter element plugging detection. That is, two detection items are generated according to the foregoing three system parameters: the engine combustion detection and the air filter element plugging detection, and a finally generated detection plan will also include the two detection items generated above.

In S103, the detection plan determined in S102 is displayed, so that a user operates the vehicle to be diagnosed according to the detection items in the detection plan.

Specifically, in this step, the detection plan obtained in S102 may be displayed to a user through a display apparatus of the electronic device such as a display screen. The detection plan at least includes the M detection items acquired in the foregoing. The user is enabled to operate the vehicle to be diagnosed according to the M detection items in the detection plan. The operation may be manual re-diagnosis for the vehicle to be diagnosed, detection of the vehicle to be diagnosed according to the detection items, handling of faults or problems existing in the vehicle to be diagnosed according to the detection items, etc.

In addition, optionally, the detection plan includes, in addition to the M detection items to be displayed to the user, provision of the overall maintenance service of the entire vehicle according to the detection items or popularization of general knowledge of vehicle maintenance to the user according to the detection items, etc. No limitations are made herein.

In one possible embodiment, the detection plan includes at least one of the following: types of all detection items included in the detection plan, description information of all detection items, execution states of all detection items and priorities of all detection items. The types of the detection items are used for classifying the detection items, so that the user can detect the vehicle to be diagnosed with the detection items according to different types. For example, engine fault detection, engine fault detection and brake fault detection of a vehicle are use type faults, and air conditioner fault detection is a maintenance type fault; or, the types of the detection items may be classified into maintenance functions, circuit diagrams, help documents, etc. When the electronic device runs different types of detection items, different information is displayed to the user. For example, when the electronic device runs a detection item in the type of a maintenance function, the detection step of the detection item is displayed to know that the user performs a detection and/or maintenance operation on the vehicle to be diagnosed. When the electronic device runs a detection item in the type of a circuit diagram, a circuit diagram of the electronic control system is displayed to assist the user in detection, diagnosis or maintenance operations on the vehicle to be diagnosed. When the electronic device runs a detection item in the type of a help document, the prompt content in the help document is displayed so as to help the user realize the detection, diagnosis or maintenance operations on the vehicle to be diagnosed.

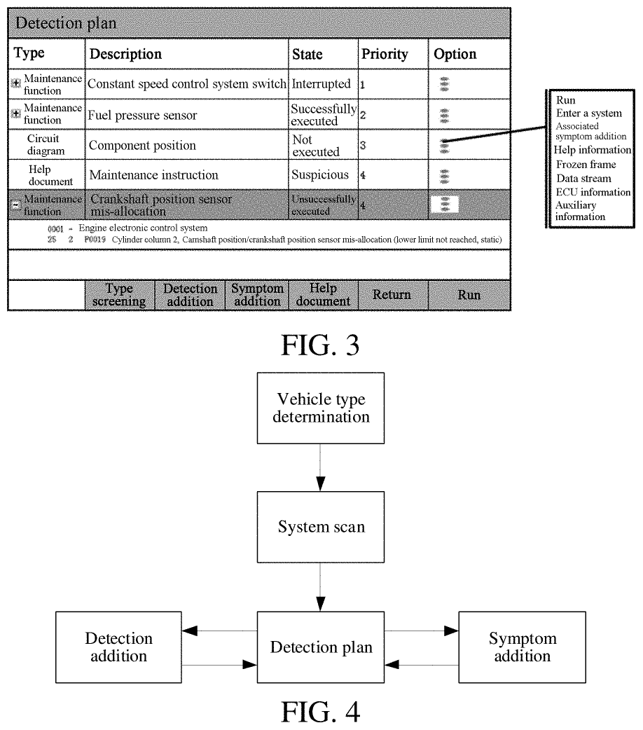

The description of the detection item may be an operation required for a specific detection item, and description information includes two display modes namely a brief description and a detailed description. For example, as shown in FIG. 3, the brief description of a detection item in the type of a maintenance function is “crankshaft position sensor mis-allocation”, and the detailed description is “0001-engine electronic control system 25 2 P0019 cylinder column 2, camshaft position/crankshaft position sensor mis-allocation (lower limit not reached, static)”. That is, the brief description of the detection item may include an object to be detected and/or a fault description, and the detailed description of the detection item may include a system to which an item to be detected belongs, a fault code, a fault code description, related symptoms, etc.

In one implementation, a brief description of a detection item is displayed in a detection plan, and a detailed description may be displayed after a click action of a user on the brief description is obtained; or, the user may view the brief description or detailed description of the detection item through different touch operations.

An execution state of the detection item is used for indicating whether the detection item is executing, executed, not executed or suspicious, that is, the suspicious state indicates that the state of the detection item is uncertain. The priority of the detection item is used for identifying the importance of the detection item. Embodiments of the priority are described in detail below.

In conclusion, in the vehicle diagnosis method provided in this embodiment, N system parameters of a vehicle to be diagnosed are acquired, and M detection items are determined according to the N system parameters to obtain a detection plan including the M detection items; and the detection plan is displayed, so that a user operates the vehicle to be diagnosed according to the detection items in the detection plan. Thus, multiple types of detection plans including detection items with different priorities can be obtained through common comprehensive evaluation according to N system parameters, and then a relatively complete and comprehensive detection plan can be made according to the mutual correlation among all the system parameters, thereby improving the efficiency in vehicle diagnosis. In addition, the vehicle diagnosis method provided in this embodiment may also achieve the following technical effects:

1. The generated detection plan is more systematic and comprehensive, and the working efficiency in vehicle diagnosis can be greatly improved.

2. The dependence on experience and knowledge of vehicle maintenance technicians is reduced, and the cost is saved for enterprises.

3. Through the guided and intelligent operation process, the learning cost of tool use is reduced.

Optionally, in S101 in the foregoing embodiment, the manner in which the electronic device serving as the executive body acquires system parameters may include, but is not limited to, the following:

1. After establishing a communication with a control system of a vehicle to be diagnosed in a wired or wireless communication manner, the electronic device acquires N system parameters from at least one system of the vehicle to be diagnosed. The communication between the electronic device and the vehicle to be diagnosed may be connection with an ECU of the vehicle to be diagnosed or connection with an apparatus capable of communicating in the vehicle to be diagnosed, such as an OBD interface, and system parameters of at least one system in the vehicle may be obtained through the apparatus. At least one system of the vehicle to be diagnosed refers to the foregoing electronic control system.

2. Key parts (such as tires, steering lamps and brake discs) of the vehicle to be diagnosed are shot by a shooting device such as a camera of the electronic device, and system parameters are determined by means of image processing.

3. The electronic device acquires system parameters of the device to be diagnosed, which are diagnosed and recorded in one or more devices specially used for vehicle diagnosis.

4. The electronic device acquires an input operation of a user and acquires N system parameters of the device to be diagnosed according to the input operation of the user.

It is to be noted that the foregoing several ways of acquiring system parameters may be used alternatively or in combination, i.e., the N system parameters acquired in S101 may be acquired in any of the foregoing ways or in combination through multiple ways. For example, J system parameters may be acquired from at least one system in the vehicle to be diagnosed, and K system parameters may be acquired according to user input, N being the sum of J and K, and J and K being positive integers. It is also possible to obtain a total of N system parameters by simply adding or removing repeated summaries of the system parameters acquired separately in the foregoing several ways.

Further, in each of the foregoing embodiments, determining M detection items according to the N system parameters in S102 specifically includes:

determining M detection items corresponding to the N system parameters according to a corresponding relationship between system parameters and detection items.

Specifically, there is a corresponding relationship between system parameters and detection items. The corresponding relationship may be stored in the foregoing electronic device for determining detection items. The corresponding relationship may be one-to-one, many-to-one or one-to-many. For example, the one-to-one corresponding relationship at least includes that a detection item corresponding to the noise of an engine being more than 40 dB is the engine combustion detection, and a detection item corresponding to black smoke of a vehicle engine is air filter element plugging detection. Or, in the many-to-one correspondence, when the noise of the engine is greater than 30 dB and the water temperature is higher than 90 degrees Celsius, a detection item corresponding to two system parameters is the engine combustion detection. In this embodiment, the corresponding relationship between system parameters and detection items may be inquired through the acquired N system parameters so as to inquire M detection items. The values of N and M may be the same or different, and are not limited herein.

And if the same detection item exists in the determined M detection items, for example, two different system parameters correspond to one detection item, it is necessary to determine M identical detection items in the detection items corresponding to all the system parameters, and taking the M identical detection items as the foregoing M detection items to ensure that the M detection items correspond to or are related to all the system parameters. Therefore, the correlation between the obtained detection item and the obtained system parameters is large, and the detection item is more accurate.

More specifically, since the system parameters acquired by the electronic device are relatively independent, when generating the detection plan, all the system parameters need to be considered comprehensively in order to formulate a comprehensive solution for the vehicle to be diagnosed, rather than simply presenting the problem itself indicated by the system parameters according to one of the system parameters. When the detection items in the detection plan are determined in this step, in addition to each problematic system parameter corresponding to one detection item, a plurality of system parameters need to be combined to jointly judge the fault problem of the vehicle and generate a corresponding detection plan. Moreover, after M detection plans are obtained, the detection plans need to be classified, and the priority of each detection item is determined. Optionally, the electronic device may determine the detection plan corresponding to the system parameters by way of local database query, or by way of Internet or server retrieval.

For example, four system parameters acquired by the electronic device include: an engine noise of 40 dB, an engine water temperature of 97 degrees Celsius, a brake failure after wading, and a peculiar smell of an air conditioner. The corresponding detection items obtained through each of the four system parameters are respectively as follows: engine fault detection, engine fault detection, brake fault detection and air conditioner fault detection. Through the first two system parameters: the engine noise of 40 dB and the engine water temperature of 97 degrees Celsius, the fault of the engine can be jointly determined to be the overload fault of the vehicle engine, so that the generated detection item is the engine combustion detection. Such a diagnosis results in a more accurate detection item than the diagnosis of a single system parameter. Furthermore, through the first three system parameters: the engine noise of 40 dB, the engine water temperature of 97 degrees Celsius and the brake failure after wading, the engine combustion fault caused by wading of the vehicle can be more specifically determined, and more accurate detection items can be obtained.

Optionally, one possible implementation of determining M detection items according to N system parameters in S101 in the foregoing embodiment is: sending N system parameters to a server, so that the server determines M detection items of the vehicle to be diagnosed according to the N system parameters; and receiving the M detection items of the vehicle to be diagnosed sent by the server.

Specifically, in addition to the foregoing embodiment, the electronic device determines M detection items directly through N system parameters. In this embodiment, the electronic device may also send the system parameters to a cloud server after acquiring the system parameters and generate a detection plan on the cloud server. Or, the detection items are determined in a local and cloud combination manner. For example, the electronic device sends system parameters meeting certain preset conditions to the cloud server, and after the cloud server determines the detection items of the vehicle to be diagnosed, the detection items are sent back to the electronic device. And for system parameters which do not meet the preset conditions, the electronic device directly determines the detection items according to the acquired system parameters. The preset conditions may be, for example, that the operation amount required by the N system parameters is larger than the processing capacity of the electronic device, or the N system parameters include system parameters which cannot be processed by all or part of the electronic device, and the electronic device sends the acquired system parameters to the cloud server when the preset conditions are met, otherwise, the detection items are generated locally and directly according to the system parameters.

Optionally, another possible implementation of determining M detection items according to N system parameters in S101 is: determining a detection plan of the vehicle to be diagnosed according to the N system parameters in combination with at least one of historical detection data of the vehicle to be diagnosed and detection data related to the vehicle to be diagnosed. Specifically, when the electronic device determines the detection items according to system parameters, historical detection data of the vehicle to be diagnosed needs to be comprehensively considered, and the most accurate detection item of the vehicle to be diagnosed is comprehensively obtained by combining related monitoring data of the vehicle to be diagnosed, such as maintenance data of vehicles of the same category. For example, the vehicle to be diagnosed has undergone the engine combustion fault maintenance for many times previously. If the engine temperature in the system parameters at this time is high, when the detection item of the engine is determined, considering that the vehicle has undergone the engine combustion fault maintenance previously, the obtained detection item is the engine combustion fault. Or, according to the maintenance data of vehicles of the same category to be diagnosed, the frequent occurrence of engine combustion faults of the vehicles of the same category is displayed, and the obtained detection item may be the engine combustion fault.

In addition, in the foregoing example, since the number of different detection items obtained at the same time is large, the importance level of the detection items needs to be sorted, so that the detection items presented to the user are marked with corresponding priorities, and it can be suggested that the user can firstly process the important detection items according to the priorities.

Then optionally, the method in the foregoing embodiment further includes: determining priorities of the M detection items; and prioritizing the M detection items in the detection plan to obtain a prioritizing result. The operations may be performed before S103, and displaying the detection plan in S103 may include: displaying the M detection items in the detection plan according to the prioritizing result.

The manner of determining priorities of the M detection items may be: determining priorities of the M detection items according to the importance of detection objects corresponding to the detection items. For example, a detection item related to an engine is marked with the highest priority level, and a detection item related to a maintenance type fault problem such as an air conditioner is marked with the lowest level. When the electronic device or other detection devices and personnel detect the vehicle to be diagnosed with the detection items, emergency detection items such as engine maintenance can be preferentially executed according to the sequence of different priorities, and faults related to the air conditioner may be executed after the engine is maintained. Or, the manner of determining priorities of the M detection items may be: determining priorities of the M detection items according to the degree of correlation between the detection items. For example, when the degree of correlation between the detection items is high, it indicates that a certain fault of the vehicle to be diagnosed may have been very serious, leading to that more system parameters are faulty and require related detection, so the priority of the detection item may be set high and the detection item can be performed preferentially.

Optionally, the method in each of the foregoing embodiments further includes: receiving system parameters or detection items input by a user; and updating the detection plan according to the system parameters or the detection items input by the user. The user such as a maintenance person or a vehicle owner may input system parameters or a detection plan to the electronic device for instructing the electronic device to update the detection plan according to the parameters or the detection items input by the user for the vehicle to be diagnosed. Specifically, according to the vehicle diagnosis method provided in this embodiment, in addition to acquiring N fixed system parameters of the vehicle to be diagnosed according to a preset mode, the electronic device may add a user-defined detection item into a detection plan of the vehicle to be diagnosed according to user-defined system parameters or detection items, or add a detection item corresponding to the user-defined system parameters. For example, when the vehicle is driven over a period of time, although there is no problem with the tire of the vehicle, when the user needs to detect the tire to determine whether the tire has failed, the electronic device in this embodiment may input the detection item as tire detection. When the electronic device receives the content input by the user, it is determined that the detection plan is tire detection. M detection items corresponding to the N system parameters acquired in S101 may be combined to jointly generate a detection plan aiming at the vehicle to be diagnosed, and finally a more comprehensive detection plan can be obtained by combining user-defined diagnosis and detection.

Furthermore, FIG. 3 is a schematic diagram of a detection plan in a vehicle diagnosis method of the present invention. An implementation of an electronic device presenting a detection plan page to a user is provided in the schematic diagram shown in FIG. 3. Type: detection terms are classified into three types: maintenance function, help document and circuit diagram. “Maintenance function” represents an executable detection item. “Help document” is a document other than a circuit diagram. Description: brief description of items to be detected. State: five types: not executed, successfully executed, unsuccessfully executed, interrupted, and suspicious. Priority: the importance of items to be detected, 1-n, where 1 indicates the highest priority. Options: operations related to a current item, including: running and entering a system, adding associated symptoms, help information, frozen frames, data streams, ECU information and auxiliary information, one or more of which may be presented as desired. Running refers to further functions of running a detection item. For example, a detection step of the detection item is displayed after the detection item in the type of a maintenance function is maintained. Other options may be selected by a user, such as entering a system, frozen frames, data streams, ECU information and auxiliary information, menus related to the other options may be displayed, or functions corresponding to the other options may be entered. For example, the user selects the other options, and detection diagnosis may be performed through the display content. The expanded list item, which is the detailed description of the detection item, may include: a belonging system, a fault code, a fault code description, related symptoms, etc.

Further, the vehicle diagnosis method in the foregoing embodiment further includes: receiving a first operation of a user for one of the M detection items; and running the detection item according to the first operation. Specifically, in Embodiment 1, after the electronic device determines the detection plan of the vehicle to be diagnosed, it may also be used to execute the detection items selected by the user in the detection plan. For example, the engine running and the air conditioner running of the vehicle to be diagnosed are automatically detected. The specific implementation may be illustrated through a display interface shown in FIG. 3. When the type of a detection item selected by the user is a maintenance function, running the detection item refers to a detection step of displaying the detection item. If the type of a detection item selected by the user is a circuit diagram or a help document, running the detection item refers to entering a display page of the circuit diagram or the help document to specifically display the related content. The first operation of the user may be to select a “running operation” corresponding to a certain detection item in the detection plan.

Further optionally, the vehicle diagnosis method in the foregoing embodiment further includes: receiving a second operation of a user for one of the M detection items; and displaying at least one detection function related to the detection item according to the second operation. The detection function refers to other operation modes except the detection step, or the detection function includes at least one system parameter, etc. For example, as shown in FIG. 3, when a user selects “data stream” in the option, the electronic device may display a “data stream” corresponding to the detection item, and the “data stream” may be acquired system parameters corresponding to the detection item, so that the user can determine the system parameters corresponding to the detection item through the second operation, and further analysis or processing can be performed. For example, the second operation of the user may be a pick operation for an option other than “running” in the options.

Further optionally, the vehicle diagnosis method in the foregoing embodiment further includes: receiving a third operation of a user for one of the M detection items; and displaying auxiliary information of the detection item according to the third operation. For example, when an item for detecting a tire by user clicking is received, auxiliary information in tire detection may be displayed to the user. The auxiliary information may be, for example, information indicating safety protection for personnel to prevent tire burst, or information indicating that an air pressure should be smaller than a preset threshold when the tire is inflated, so as to assist and prompt the user to pay attention to item detection. For example, as shown in FIG. 3, the third operation of the user may be a user selection operation for an option of “auxiliary information” in the options.

Further optionally, the vehicle diagnosis method in the foregoing embodiment further includes: receiving a fourth operation of a user for one of the M detection items; and displaying detailed description information of the detection item according to the fourth operation. Specifically, for example, in the display interface shown in FIG. 3, the description of the detection item is only a brief description, and the detailed description may be displayed after the user's viewing operation of the brief description is detected.

Further optionally, the vehicle diagnosis method in the foregoing embodiment further includes: updating, after detecting that a user operates the vehicle to be diagnosed according to a detection item in the detection plan, an execution state of the detection item according to the operation of the user for the vehicle to be diagnosed. Specifically, for example, in the display interface shown in FIG. 3, when a user operates a constant speed control system switch in, for example, the first maintenance function, the state may be modified from “interrupted” to “successfully executed”. Specifically, after the user operates the vehicle to be diagnosed according to a detection item, the electronic device may receive a determination instruction after the user operation, the electronic device may acquire an operation result of the user operating the vehicle to be diagnosed from the vehicle to be diagnosed according to the determination instruction, the execution state of the detection item is updated according to the operation result, and if the operation result is not obtained, the execution state may be updated to be suspicious.

FIG. 4 is a schematic flow diagram of Embodiment 2 of a vehicle diagnosis method of the present invention. The embodiment shown in FIG. 4 is a more specific implementation of a vehicle diagnosis method, which includes the following steps: firstly, a specific vehicle type is determined by manually selecting or automatically determining through VIN codes, and then comprehensive system scanning is performed; then, a diagnosis system automatically generates, according to a system scanning result, a detection plan according to a diagnosis information database; a user may add a fault symptom on a detection plan interface; the user may add a self-defined detection item on the detection plan interface; and the diagnosis system updates the detection plan according to the content added by the user and the current overall condition.

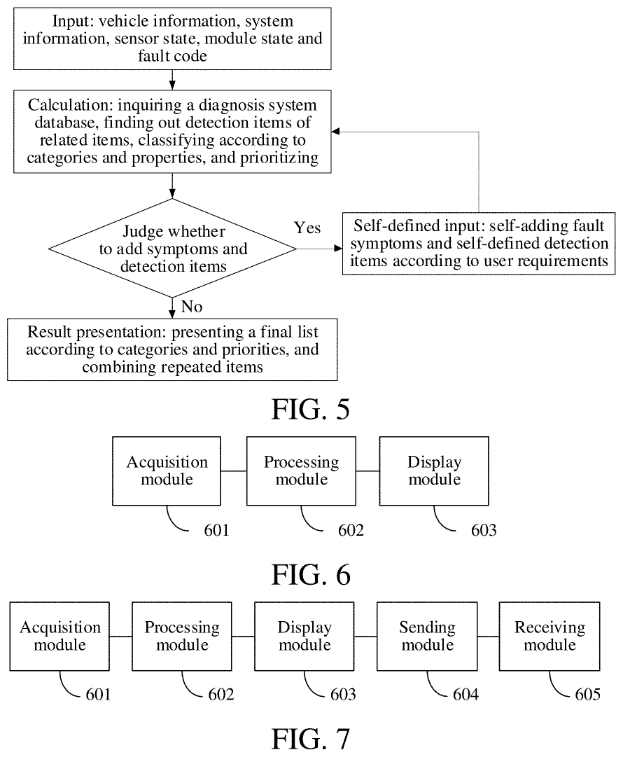

FIG. 5 is a schematic flow diagram of Embodiment 3 of a vehicle diagnosis method of the present invention. The embodiment shown in FIG. 5 is a more specific implementation for determining a detection plan in a vehicle diagnosis method, which includes the following steps: input: collecting as comprehensive information as possible through system scanning or user input, such as vehicle information, system information, sensor states, module states and fault codes; calculation: inquiring a database related to a diagnosis system according to the input information, finding out the most matched detection item, and classifying and sequencing; and self-defined input: if a user needs to input a fault symptom or add a detection item, jumping to the step. Otherwise, the process jumps to result display: sorting and classifying all the detection items to form a detection plan for presentation, the detection plan including descriptions and partial attributes of the detection items.

FIG. 6 is a schematic structure diagram of Embodiment 1 of a vehicle diagnosis apparatus of the present invention. As shown in FIG. 6, the vehicle diagnosis apparatus in this embodiment includes an acquisition module 601, a processing module 602 and a display module 603. The acquisition module 601 is configured to acquire N system parameters of a vehicle to be diagnosed, N being a positive integer. The processing module 602 is configured to determine M detection items according to the N system parameters to obtain a detection plan including the M detection items, M being a positive integer. The display module 603 is configured to display the detection plan, so that a user operates the vehicle to be diagnosed according to the detection items in the detection plan.

The vehicle diagnosis apparatus provided in this embodiment is configured to execute the vehicle diagnosis method as shown in FIG. 2. An implementation manner and principle are the same. Details are not described again.

Optionally, the acquisition module 601 is specifically configured to: acquire, after establishing a communication with the vehicle to be diagnosed, the N system parameters from at least one system of the vehicle to be diagnosed; and/or, acquire the system parameters of the vehicle to be diagnosed according to an input operation of the user.

Optionally, the processing module 602 is specifically configured to determine M detection items corresponding to the N system parameters according to a corresponding relationship between system parameters and detection items.

Optionally, the processing module 602 is specifically configured to determine detection items corresponding to all system parameters in the N system parameters, and determine M detection items from the detection items corresponding to all the system parameters.

Optionally, the processing module 602 is specifically configured to determine M identical detection items in the detection items corresponding to all the system parameters, and take the M identical detection items as the M detection items.

Optionally, the processing module 602 is specifically configured to delete repeated detection items in the detection items corresponding to all the system parameters, and take M detection items remaining after deletion as the M detection items.

Optionally, the processing module 602 is specifically configured to determine a detection plan of the vehicle to be diagnosed according to the N system parameters in combination with at least one of historical detection data of the vehicle to be diagnosed and detection data related to the vehicle to be diagnosed.

The vehicle diagnosis apparatus provided in this embodiment is configured to execute the vehicle diagnosis method shown in the foregoing embodiment. An implementation manner and principle are the same. Details are not described again.

FIG. 7 is a schematic structure diagram of Embodiment 2 of a vehicle diagnosis apparatus of the present invention. As shown in FIG. 7, the vehicle diagnosis apparatus provided in this embodiment further includes a sending module 604 and a receiving module 605 on the basis of the embodiment shown in FIG. 6. The sending module 604 is configured to send the N system parameters to a server, so that the server determines M detection items of the vehicle to be diagnosed according to the N system parameters. The receiving module 605 is configured to receive the M detection items of the vehicle to be diagnosed sent by the server.

The vehicle diagnosis apparatus provided in this embodiment is configured to execute the vehicle diagnosis method shown in the foregoing embodiment. An implementation manner and principle are the same. Details are not described again.

Optionally, the processing module 602 is further configured to: determine priorities of the M detection items according to the importance of detection objects corresponding to the detection items; or, determine priorities of the M detection items according to the degree of correlation between the detection items.

Optionally, the processing module 602 is further configured to receive system parameters or detection items input by a user, and update the detection plan according to the system parameters or the detection items input by the user.

Optionally, the processing module 602 is further configured to receive a first operation of a user for one of the M detection items, and run the detection item according to the first operation.

Optionally, the processing module 602 is further configured to receive a second operation of a user for one of the M detection items. The display module 603 is further configured to display at least one detection function related to the detection item according to the second operation.

Optionally, the processing module 602 is further configured to receive a third operation of a user for one of the M detection items. The display module 603 is further configured to display auxiliary information of the detection item according to the third operation.

Optionally, the processing module 602 is further configured to receive a fourth operation of a user for one of the M detection items. The display module 603 is further configured to display detailed description information of the detection item according to the fourth operation.

Optionally, the processing module 602 is specifically configured to displaying at least one of the following information: types of all detection items included in the detection plan, description information of all detection items, execution states of all detection items and priorities of all detection items.

Optionally, the system parameters include at least one of the following: vehicle information, system information, sensor state, module state, fault code and fault symptom of the vehicle to be diagnosed.

The vehicle diagnosis apparatus provided in this embodiment is configured to execute the vehicle diagnosis method shown in the foregoing embodiment. An implementation manner and principle are the same. Details are not described again.

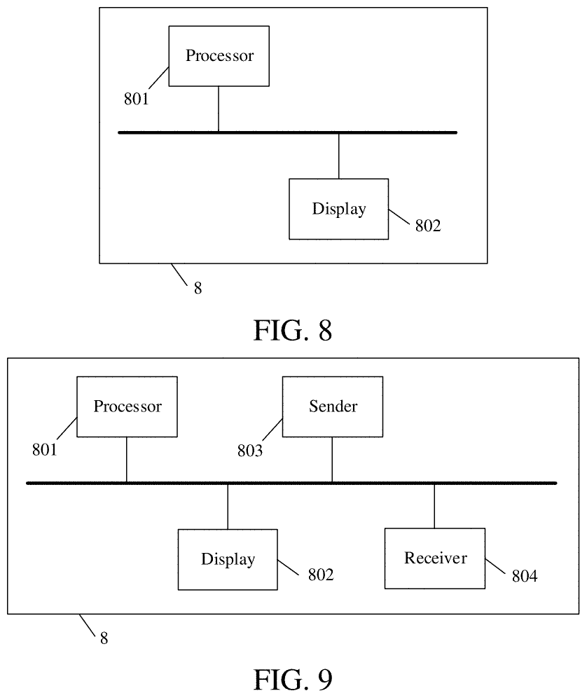

FIG. 8 is a schematic structure diagram of Embodiment 3 of a vehicle diagnosis apparatus of the present invention. As shown in FIG. 8, the vehicle diagnosis apparatus provided in this embodiment includes:

a processor 801 and a display 802. The processor 801 is configured to acquire N system parameters of a vehicle to be diagnosed, N being a positive integer. The processing module is further configured to determine M detection items according to the N system parameters to obtain a detection plan including the M detection items, M being a positive integer. The display 802 is configured to display the detection plan, so that a user operates the vehicle to be diagnosed according to the detection items in the detection plan.

The vehicle diagnosis apparatus provided in this embodiment is configured to execute the vehicle diagnosis method as shown in FIG. 2. An implementation manner and principle are the same. Details are not described again.

Optionally, the processor 801 is specifically configured to: acquire, after establishing a communication with the vehicle to be diagnosed, the N system parameters from at least one system of the vehicle to be diagnosed; and/or, acquire the system parameters of the vehicle to be diagnosed according to an input operation of the user.

Optionally, the processor 801 is specifically configured to determine M detection items corresponding to the N system parameters according to a corresponding relationship between system parameters and detection items.

Optionally, the processor 801 is specifically configured to determine detection items corresponding to all system parameters in the N system parameters, and determine M detection items from the detection items corresponding to all the system parameters.

Optionally, the processor 801 is specifically configured to determine M identical detection items in the detection items corresponding to all the system parameters, and take the M identical detection items as the M detection items.

Optionally, the processor 801 is specifically configured to delete repeated detection items in the detection items corresponding to all the system parameters, and take M detection items remaining after deletion as the M detection items.

Optionally, the processor 801 is specifically configured to determine a detection plan of the vehicle to be diagnosed according to the N system parameters in combination with at least one of historical detection data of the vehicle to be diagnosed and detection data related to the vehicle to be diagnosed.

The vehicle diagnosis apparatus provided in this embodiment is configured to execute the vehicle diagnosis method shown in the foregoing embodiment. An implementation manner and principle are the same. Details are not described again.

FIG. 9 is a schematic structure diagram of Embodiment 4 of a vehicle diagnosis apparatus of the present invention. As shown in FIG. 9, the vehicle diagnosis apparatus provided in this embodiment further includes a sender 803 and a receiver 804 on the basis of the embodiment shown in FIG. 8. The sender 803 is configured to send the N system parameters to a server, so that the server determines M detection items of the vehicle to be diagnosed according to the N system parameters. The receiver 804 is configured to receive the M detection items of the vehicle to be diagnosed sent by the server.

The vehicle diagnosis apparatus provided in this embodiment is configured to execute the vehicle diagnosis method shown in the foregoing embodiment. An implementation manner and principle are the same. Details are not described again.

Optionally, the processor 801 is further configured to: determine priorities of the M detection items according to the importance of detection objects corresponding to the detection items; or, determine priorities of the M detection items according to the degree of correlation between the detection items.

Optionally, the processor 801 is further configured to receive system parameters or detection items input by a user, and update the detection plan according to the system parameters or the detection items input by the user.

Optionally, the processor 801 is further configured to receive a first operation of a user for one of the M detection items, and run the detection item according to the first operation.

Optionally, the processor 801 is further configured to receive a second operation of a user for one of the M detection items. The display 802 is further configured to display at least one detection function related to the detection item according to the second operation.

Optionally, the processor 801 is further configured to receive a third operation of a user for one of the M detection items. The display 802 is further configured to display auxiliary information of the detection item according to the third operation.

Optionally, the processor 801 is further configured to receive a fourth operation of a user for one of the M detection items. The display 802 is further configured to display detailed description information of the detection item according to the fourth operation.

Optionally, the processor 801 is specifically configured to displaying at least one of the following information: types of all detection items included in the detection plan, description information of all detection items, execution states of all detection items and priorities of all detection items.

Optionally, the system parameters include at least one of the following: vehicle information, system information, sensor state, module state, fault code and fault symptom of the vehicle to be diagnosed.

The vehicle diagnosis apparatus provided in this embodiment is configured to execute the vehicle diagnosis method shown in the foregoing embodiment. An implementation manner and principle are the same. Details are not described again.

The present application further provides a vehicle diagnosis system, which includes N vehicle diagnosis apparatuses as described in any of the foregoing embodiments of FIG. 5 and M vehicles to be diagnosed as described in any of the foregoing embodiments, M and N being positive integers.

The present application further provides a vehicle diagnosis apparatus, which includes a processor and a memory. The memory is configured to store programs. The processor is configured to call the programs stored in the memory to execute the vehicle diagnosis method as described in any of the foregoing embodiments.

The present application further provides a computer-readable storage medium, which stores a program code. The program code, when executed, executes the vehicle diagnosis method as described in any of the foregoing embodiments.

The present application further provides a computer program product. A program code included in the computer program product, when executed by a processor, implements the vehicle diagnosis method as described in any of the foregoing embodiments.

A person of ordinary skill in the art may understand that all or some of the steps of the method embodiments may be implemented by a program instructing relevant hardware. The foregoing program may be stored in a computer-readable storage medium. When the program is run, the steps of the method embodiments are performed. The foregoing storage medium includes any medium that can store program code, such as a ROM, a RAM, a magnetic disk, or an optical disc.

Finally, it is to be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without making the essence of the corresponding technical solutions departing from the scope of the technical solutions of the embodiments of the present invention.

What is claimed is:

1. A vehicle diagnosis method, comprising:
acquiring N system parameters of a vehicle to be diagnosed, N being a positive integer;
determining M detection items according to the N system parameters to obtain a detection plan comprising the M detection items, M being a positive integer; and
displaying the detection plan, so that a user operates the vehicle to be diagnosed according to the detection items in the detection plan.

2. The method according to claim 1, wherein acquiring N system parameters of a vehicle to be diagnosed comprises:
acquiring, after establishing a communication with the vehicle to be diagnosed, the N system parameters from at least one system of the vehicle to be diagnosed; and/or,
acquiring the N system parameters of the vehicle to be diagnosed according to an input operation of the user.

3. The method according to claim 1, wherein determining M detection items according to the N system parameters comprises:
determining M detection items corresponding to the N system parameters according to a corresponding relationship between system parameters and detection items.

4. The method according to claim 3, wherein determining M detection items corresponding to the N system parameters according to a corresponding relationship between system parameters and detection items comprises:
determining detection items corresponding to all system parameters in the N system parameters; and
determining M detection items from the detection items corresponding to all the system parameters.

5. The method according to claim 4, wherein determining M detection items from the detection items corresponding to all the system parameters comprises:
determining M identical detection items in the detection items corresponding to all the system parameters; and
taking the M identical detection items as the M detection items.

6. The method according to claim 4, wherein determining M detection items from the detection items corresponding to all the system parameters comprises:
deleting repeated detection items in the detection items corresponding to all the system parameters, and taking M detection items remaining after deletion as the M detection items.

7. The method according to claim 1, wherein determining M detection items according to the N system parameters comprises:
determining a detection plan of the vehicle to be diagnosed according to the N system parameters in combination with at least one of historical detection data of the vehicle to be diagnosed and detection data related to the vehicle to be diagnosed.

8. The method according to claim 1, wherein determining M detection items according to the N system parameters comprises:
sending the N system parameters to a server, so that the server determines M detection items of the vehicle to be diagnosed according to the N system parameters; and
receiving the M detection items of the vehicle to be diagnosed sent by the server.

9. The method according to claim 1, further comprising:
determining priorities of the M detection items; and
prioritizing the M detection items in the detection plan to obtain a prioritizing result,
wherein displaying the detection plan comprises:
displaying the M detection items in the detection plan according to the prioritizing result.

10. The method according to claim 9, wherein determining priorities of the M detection items comprises:
determining priorities of the M detection items according to the importance of detection objects corresponding to the detection items; or,
determining priorities of the M detection items according to the degree of correlation between the detection items.

11. The method according to claim 1, wherein after displaying the detection plan, the method further comprises:
receiving system parameters or detection items input by a user; and
updating the detection plan according to the system parameters or the detection items input by the user.

12. The method according to claim 1, further comprising:
receiving a first operation of a user for one of the M detection items; and
running the detection item according to the first operation.

13. The method according to claim 1, further comprising:
receiving a second operation of a user for one of the M detection items; and
displaying at least one detection function related to the detection item according to the second operation.

14. The method according to claim 1, further comprising:
receiving a third operation of a user for one of the M detection items; and
displaying auxiliary information of the detection item according to the third operation.

15. The method according to claim 1, further comprising:
receiving a fourth operation of a user for one of the M detection items; and
displaying detailed description information of the detection item according to the fourth operation.

16. The method according to claim 1, further comprising:
updating, after detecting that a user operates the vehicle to be diagnosed according to a detection item in the detection plan, an execution state of the detection item according to the operation of the user for the vehicle to be diagnosed.

17. The method according to claim 1, wherein displaying the detection plan comprises:
displaying at least one of the following information:
types of all detection items comprised in the detection plan, description information of all detection items, execution states of all detection items and priorities of all detection items.

18. The method according to claim 1, wherein the system parameters comprise at least one of the following:
vehicle information, system information, sensor state, module state, fault code and fault symptom of the vehicle to be diagnosed.

19. A vehicle diagnosis apparatus, comprising:
a processor, configured to acquire N system parameters of a vehicle to be diagnosed, N being a positive integer, the processor being further configured to determine M detection items according to the N system parameters to obtain a detection plan comprising the M detection items, M being a positive integer; and
a display, configured to display the detection plan, so that a user operates the vehicle to be diagnosed according to the detection items in the detection plan.

20. The apparatus according to claim 19, wherein the processor is specifically configured to:
acquire, after establishing a communication with the vehicle to be diagnosed, the N system parameters from at least one system of the vehicle to be diagnosed; and/or,
acquire the system parameters of the vehicle to be diagnosed according to an input operation of the user.
